(19) United States
(12) Patent Application Publication
(10) Pub. No.: US 2026/0342607 A1
(43) Pub. Date: Oct. 29, 2026

(54) METHOD FOR ESTABLISHING A CONTROL CONNECTION, MOBILE TERMINAL DEVICE, SET COMPRISING A MOBILE TERMINAL DEVICE AND A HOUSEHOLD APPLIANCE AND METHOD FOR RETROFITTING A HOUSEHOLD APPLIANCE

(71) Applicant: Jura Elektroapparate AG, Niederbuchsiten (CH)

(72) Inventor: Amir KARIMIAN, Füllinsdorf (CH)

(73) Assignee: Jura Elektroapparate AG, Niederbuchsiten (CH)

(21) Appl. No.: 19/113,486

(22) PCT Filed: Nov. 7, 2023
(86) PCT No.: PCT/EP2023/080967

§ 371 Date: Mar. 20, 2025

(30) Foreign Application Priority Data
Nov. 9, 2022 (EP) 22206470.1

(51) Int. Cl. H04L 12/28

(52) U.S. Cl. CPC H04L 12/2809; H04L 2012/2841; H04L 2012/285

(57) ABSTRACT

A method for establishing a control connection between a household appliance, i.e., a coffee machine, and a mobile terminal device, i.e., a smartphone, wherein information which is readable from the outside, preferably without contact, is held on or at the household appliance. The method includes machine reading of the information, checking whether a data connection has already been established to this information in the past, and, if a result of the check is negative, establishing a preferably direct data connection between the household appliance and the mobile terminal device to obtain a machine-specific identifier from the household appliance and assignment of the identifier to the information, or, if the result is positive, use of the identifier to establish the control connection. A mobile terminal device for carrying out a method and a set consisting of a mobile terminal device and a household appliance are also provided.

### CROSS-REFERENCE TO RELATED APPLICATIONS

This application is a U.S. National Phase application of PCT/EP2023/080967, filed Nov. 7, 2023, which claims priority from European Patent Application No. 22206470.1, filed Nov. 7, 2023, both of which are incorporated herein by reference as if fully set forth.

### TECHNICAL FIELD

The invention relates to a method for establishing a control connection between a household appliance and a mobile terminal device. The household appliance may be, for example, a coffee machine, such as, in particular, a fully automatic coffee machine. The mobile terminal device can be, for example, a smartphone or a tablet.

### BACKGROUND

In order to simplify the operation of a household appliance for a user, it is already possible to connect it to mobile terminal devices in order to transmit commands to the household appliance via an easy-to-use user interface using a mobile terminal device.

In order to establish a preferably secure control connection between a mobile terminal device and a household appliance so that the household appliance can be controlled via the mobile terminal device during normal operation, it is necessary for a user to first link their mobile terminal device to the household appliance (this step is also referred to as “pairing” or “onboarding”).

### SUMMARY

The object is to improve the linking step between a mobile terminal device and a household appliance.

A solution to this object is provided by a method for establishing a control connection between a household appliance and a mobile terminal device having one or more of the features disclosed herein.

In particular, a method of the aforementioned type is proposed for solving the object, wherein information which can be read out from the outside, preferably without contact, for example information which is not specific to the appliance and/or is independent of a machine-specific identifier, is arranged on or can be called up at the household appliance, characterized by the following steps:
machine reading of the information using the mobile terminal device
checking whether a data connection has already been established to this information in the past and/or whether a machine-specific identifier has already been assigned to this information in the past, and,
if the result of the check is negative, establishing a preferably direct data connection between the household appliance and the mobile terminal device to obtain a machine-specific identifier from the household appliance and assigning the identifier to the information, or,
if the result of the check is positive, using the identifier to establish the control connection.

If no data connection to the readable information has been established in the past, this information is not yet assigned to the machine-specific identifier of the household appliance and could theoretically also be assigned to a machine-specific indicator of another household appliance. In other words, the readable information can initially be information that is independent of the machine-specific identifier. This has the advantage that, when assigning the readable information to the household appliance, it is not necessary to check whether the readable information (which generally cannot be read by a person without assistance) belongs to the household appliance or has been correctly assigned to it. If the readable information were already specific to a household appliance or a particular model of a household appliance, this would create a potential source of error, as such household appliance-specific readable information could be assigned to an incorrect household appliance, such as an incorrect model and/or an incorrect location. This in turn could result in a control connection being set up incorrectly and/or commands transmitted to the household appliance for control by means of the mobile terminal device being incompatible. According to the invention, the readable information can therefore be assigned to the identifier by establishing a data connection between the mobile terminal device and the household appliance for the first time. For example, a data connection can preferably be established automatically with a mobile terminal device that is closest to the household appliance locally and/or that has the strongest connection signal. Once the readable information has been assigned to the identifier, a control connection, i.e. preferably another data connection for normal operation, can be established between the mobile terminal device and the household appliance. In cases where an assignment has already been made between the readable information and the identifier, it is no longer necessary to carry out this assignment step again. The identifier can therefore be used directly to establish a control connection. The invention thus makes it possible to obtain information required to establish a control connection between a mobile terminal device and a household appliance without the household appliance having to be connected to the Internet or a central instance each time the control connection is established. The invention also allows the use of simple storage means, in particular unchangeable storage means such as imprints, to provide the readable information.

Advantageous further developments of the invention are described below, which can be combined with the features noted above or with the features of other further developments described and/or claimed herein.

According to an advantageous further development of the method, when checking whether a data connection has already been established to this information in the past, in particular whether a data connection that differs from the control connection has been established, it is possible to check whether a machine-specific identifier assigned to the information is available in the mobile terminal device and/or on an external memory, such as a server, and/or on the household appliance. Alternatively or additionally, it is also possible to verify whether information about a successful check has taken place in the past, for example by reading out a corresponding control bit. This can be used, for example, to determine connection data.

According to one possible design, the assignment between readable information and identifier can be stored on the mobile terminal device. This has the advantage that the user only has to link his mobile terminal device to the household appliance once using the method described in order to then be able to access the control connection set up to control the household appliance using the same mobile terminal device. It is also conceivable that by carrying out the method once, the user can use a control connection with identical household appliances at possibly other locations without having to set up the control connection with the identical household appliance again. For example, it could be possible for the household appliance to read the mobile terminal device.

Alternatively or additionally, the assignment of the identifier to the information can also be stored with the household appliance, in particular as part of the readable information.

According to a further advantageous design, the household appliance can be selected on the mobile terminal device, preferably manually, from a list of available connection subscribers when the data connection is established. This enables the user to select the household appliance with which a control connection is to be set up using the method described.

According to another advantageous design, the assignment of the identifier to the information can be stored in the mobile terminal device. As already described above, this has the advantage that the user only has to link his mobile terminal device to the household appliance once using the method described in order to then be able to access the control connection established to control the household appliance.

In order to be able to establish a control connection between the mobile terminal device and the household appliance securely and/or as quickly as possible after initial setup, it may be advantageous if the identifier contains connection data. For example, this can be a preferably coded identifier of the household appliance.

It may also be advantageous, particularly in order to establish a secure control connection between the mobile terminal device and the household appliance, if the information contains an individual character string with which it can be uniquely identified. This character string can be generated randomly, for example. The individual character string makes it easy to avoid confusion or incorrect assignment.

It can be particularly advantageous if, after the information has been read in, an automatic check is made as to whether an associated app for operating the control connection is installed. In particular, it may be provided that a connection to the Internet is established to obtain the app if this is not the case and/or that the app is called up if this is the case.

According to an advantageous further development, the information can be selected independently of the identifier. This makes it possible to transmit the information to the mobile terminal device via a large number of different signal transmitters and read it out by the mobile terminal device. The mobile terminal device basically only needs to have receiving means in order to be able to receive and evaluate the information.

Furthermore, the machine-specific identifier can be stored in the information and/or stored in advance. Preferably, it may occur that the identifier is or can be stored on an NFC tag. Particularly preferably, a user can store the identifier in the information by executing the method for establishing a control connection as described herein and/or claimed below. Subsequent users who read in the information by machine for the first time then do not need to carry out the complete method for setting up the control connection, but can set up the control connection more quickly, since in this design of the invention the assignment of the information with the identifier is stored directly in the information.

In order to be able to carry out the method as location-independently as possible, the establishment of the data connection and/or the establishment of the control connection can be carried out locally. In particular, it may be possible to establish the data connection and/or the control connection when the mobile terminal device and/or the household appliance is/are disconnected from the Internet.

According to an advantageous further development, the information can be read mechanically and/or magnetically and/or electromagnetically and/or acoustically and/or optically. Particularly preferably, the information can be provided on an RFID tag (also known as an NFC tag) and/or in an optically readable code, in particular in a one-dimensional code or in a two-dimensional matrix code.

According to a further advantageous further development, the assignment of the identifier to the information can be stored on an external memory, in particular on a server, so that it can be retrieved. The assignment can therefore be stored centrally and retrieved from the external memory when the information is read out again. This makes it possible, for example, for the assignment stored on the external memory to also be retrieved and used by new mobile terminal devices, preferably without having to carry out the complete method described for establishing a control connection on this new end device itself.

The invention further relates to a mobile terminal device, in particular a smartphone or a tablet, having means for carrying out a method as described and/or claimed herein.

The invention also relates to a set consisting of a mobile terminal device as described and/or claimed herein, and a household appliance, in particular a coffee machine, wherein information which can preferably be used for carrying out a method as described and/or claimed herein is held ready on the household appliance, in particular in an RFID tag and/or in a two-dimensional matrix code.

The invention further relates to a method for retrofitting a household appliance with a machine-specific identifier and/or information for carrying out the method, as described herein and/or claimed below. This enables a user to subsequently assign a preferably unspecific piece of information to his household appliance and associate it with a machine-specific identifier of his household appliance. This can be carried out, for example, using an NFC tag that is attached to the household appliance or at least placed nearby. This has the advantage that a user can also retrofit their household appliance at a later point in time, for example after initial commissioning has already taken place, in order to be able to set up a preferably alternative control system by establishing the control connection.

### BRIEF DESCRIPTION OF THE DRAWINGS

The invention will now be described in more detail with reference to multiple exemplary embodiments, but is not limited to these exemplary embodiments. Further exemplary embodiments result from the combination of the features of individual or multiple claims with one another and/or with individual or multiple features of the embodiments, wherein:

FIG. 1 shows a first possible embodiment variant of a method according to the invention for establishing a control connection between a household appliance and a mobile terminal device, wherein an NFC tag is used as a carrier of the readable information in order to establish a data connection, wherein an assignment of the identifier to the information is made on the mobile terminal device and stored thereon, and wherein a control connection between the household appliance and the mobile terminal device is finally established via another, preferably wireless data connection, such as WiFi or BLE (Bluetooth Low Energy),

FIG. 2 shows a second possible embodiment variant of a method according to the invention for establishing a control connection between a household appliance and a mobile terminal device, wherein an NFC tag is used as a carrier of the readable information in order to establish a data connection, wherein an assignment of the identifier to the information is stored on the external memory, and wherein a control connection between the household appliance and the mobile terminal is finally established via another, preferably wireless data connection, such as WiFi or BLE (Bluetooth Low Energy),

FIG. 3 shows a third possible embodiment variant of a method according to the invention for establishing a control connection between a household appliance and a mobile terminal device, wherein an NFC tag is used as a carrier of the readable information in order to establish a data connection, wherein an assignment of the identifier to the information is stored on the mobile terminal device, and wherein a control connection between the household appliance and the mobile terminal device is finally established via another, preferably wireless data connection, such as WiFi or BLE (Bluetooth Low Energy).

### DETAILED DESCRIPTION

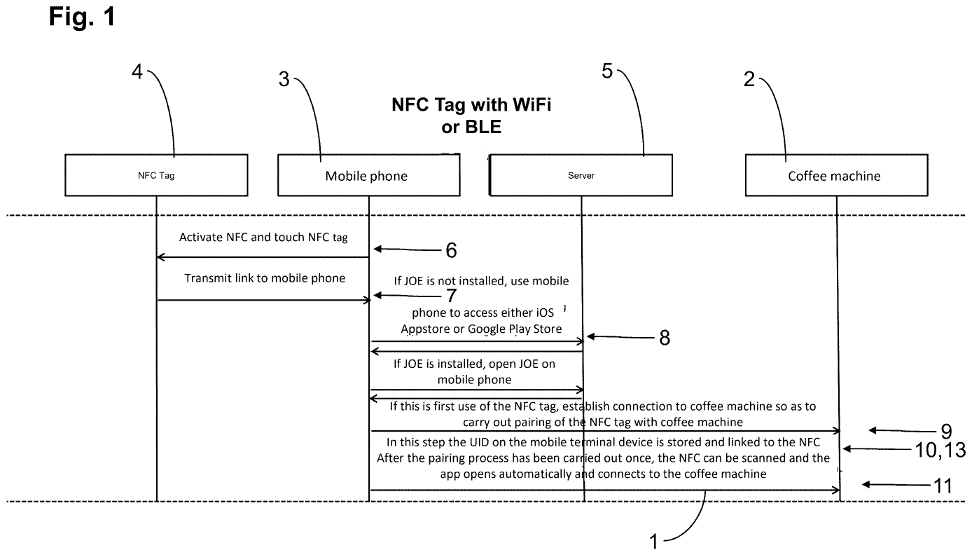

FIGS. 1-3 each schematically show exemplary embodiments of a method according to the invention for establishing a control connection 1 between a household appliance 2 and a mobile terminal device 3.

The household appliance 2 can, for example, be designed as a coffee machine, preferably a fully automatic coffee machine.

The household appliance 2 has at least one data connection device for establishing a data connection 7 in order to be able to be connected to a mobile terminal device 3, in particular a local mobile terminal device 3, i.e. located in the reception area of the household appliance, and/or a network and/or the Internet.

The mobile terminal device 3 can be designed as a smartphone, for example. The mobile terminal device 3 has at least one data connection device for establishing a data connection 7 in order to be able to be connected to an appropriately equipped, in particular local, household appliance and/or a network and/or the Internet.

FIGS. 1-3 show exemplary embodiments in which the household appliance 2 and the mobile terminal device 3 can be connected to each other via data connection devices using NFC and/or WiFi and/or BLE.

The method according to the invention is used to establish a control connection 1 between a mobile terminal device 3 and a household appliance 2 to be operated by means of the mobile terminal device 3.

For this purpose, information 4, which can preferably be read without contact by means of the mobile terminal device 3, is arranged or can be called up on or near the household appliance 2, for example in or on a housing part. The information 4 does not necessarily have to be arranged directly on the household appliance 2, but it is only necessary for a user to clearly assign the information 4 to a household appliance 2.

In this step, machine reading 5 of the information 4 is thus carried out. However, the information 4 could also be stored in another form, such as a graphically scannable matrix code. Furthermore, the information 4 may be randomly generated information 4, such as a randomly generated character identifier or character string.

In principle, specific connection parameters can be added to the information 4 after the data connection 7 has been established for the first time in order to enable reliable and unambiguous identification. However, the aforementioned connection parameters can also be stored together with the assignment 11 of the identifier 10 to the information 4, which is described in more detail below, preferably without changing the original information 4.

In the exemplary embodiments shown in FIGS. 1-3, the readable information 4 is stored by an NFC tag (RFID tag) and may, for example, comprise a randomly generated number or identifier. If NFC is activated on the mobile terminal device 3 and the NFC tag is activated, a data connection 7 can be established between the NFC tag coupled to the household appliance 2 and the mobile terminal device 3.

When establishing the data connection 7, it is possible for a user to be prompted on the mobile terminal device 3 to make a selection of the household appliance 2 to be connected. For this purpose, a list of all connection subscribers located, for example, in the reception area of the mobile terminal device 3 can be displayed, from which the user can make a selection manually. It is also conceivable that a data connection 7 is established automatically, for example if there is only one connection subscriber in the reception area of the mobile terminal device 3.

The previously described step of establishing the data connection 7 preferably automatically initiates a check step 8 on the mobile terminal device 3 to check whether software required to control the household appliance 2 by means of the mobile terminal device 3 (the app is abbreviated as JOE in the figures). Using the software, it is possible to transmit operating commands to the household appliance 2.

If the software is not yet installed on the mobile terminal device 3, the user is prompted to install the software on the mobile terminal device 3 or the software is installed automatically.

If the software has already been properly installed, the software is started on the mobile terminal device 3 by the step described above.

This is followed by a further check step 9, which checks whether a data connection 7 has already been established to the read-in information 4 in the past and/or whether a machine-specific identifier 10 has already been assigned to the information 4 in the past.

If a result of this check 9 is negative, i.e. no data connection 7 has yet been established in the past in relation to the information 4 read in and/or no machine-specific identifier 10 has yet been assigned, a preferably direct data connection 7 is first established between the household appliance 2 and the mobile terminal device 3 to obtain a machine-specific identifier 10 from the household appliance 2.

In a subsequent assignment step 11, the identifier 10 is then assigned to the information 4 and this assignment 11 is stored.

According to an optional embodiment variant, it may be provided that the machine-specific identifier 10 and/or its assignment 11 to the information 4 is also stored in the information 4 after the method for establishing a control connection 1 has been carried out once. Subsequent reading of the information 4 by another mobile terminal device 3 thus allows the control connection 1 to be established directly by means of the other mobile terminal device 3, without the intermediate step described above for establishing a data connection 7 to obtain a machine-specific identifier 10 being necessary.

However, if the result of the check 9 is positive, i.e. a data connection 4 has already been established in the past, a use 12 of the identifier 10 is carried out to establish the control connection 1 between the household appliance 2 and the mobile terminal device 3. The identifier 10 may contain the connection data required to establish the control connection 1, preferably without which it would not be possible to establish the control connection 1.

The aforementioned information 4 can in principle be independent of the identifier 10. These two are only linked together by the assignment step 11.

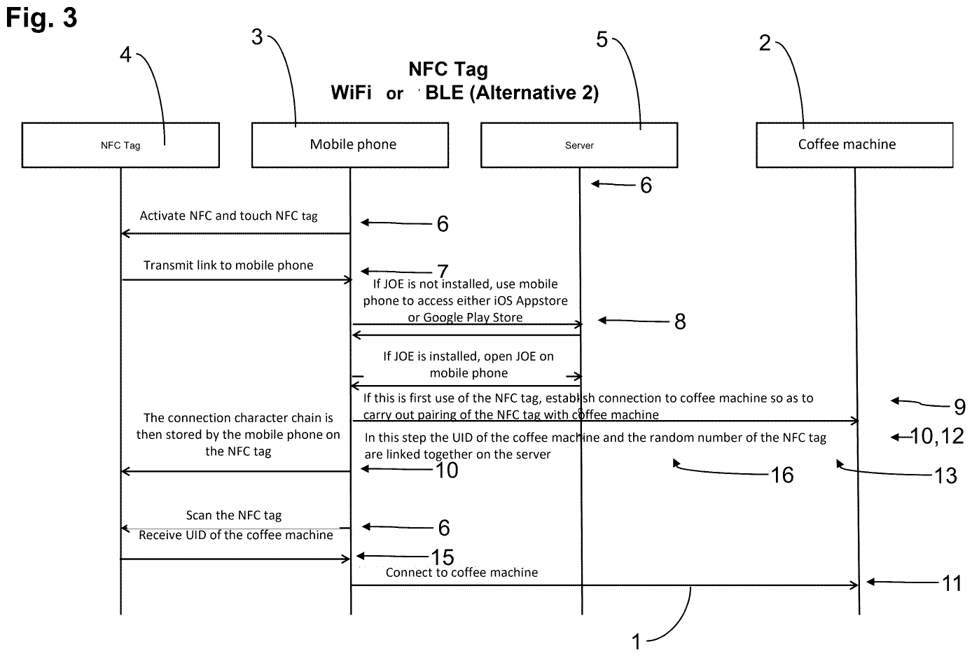

The storage of the assignment 11 between the read-in information 4 and the machine-specific identifier 10 can be stored locally, i.e. in the household appliance 2 and/or in the mobile terminal device 3, as in the embodiment examples shown in FIGS. 1 and 3. The advantage of this embodiment variant is that in a renewed reading 6 of the information by using the mobile terminal device 3, it is possible to determine whether a data connection 7 has already been successfully established in the past using check step 9. For this check step 9, it is therefore not necessary for the household appliance 2 and/or the mobile terminal device 3 to be connected to an external memory 5 and/or the Internet. A local data connection 7 between the two devices is sufficient to finally establish a control connection 1.

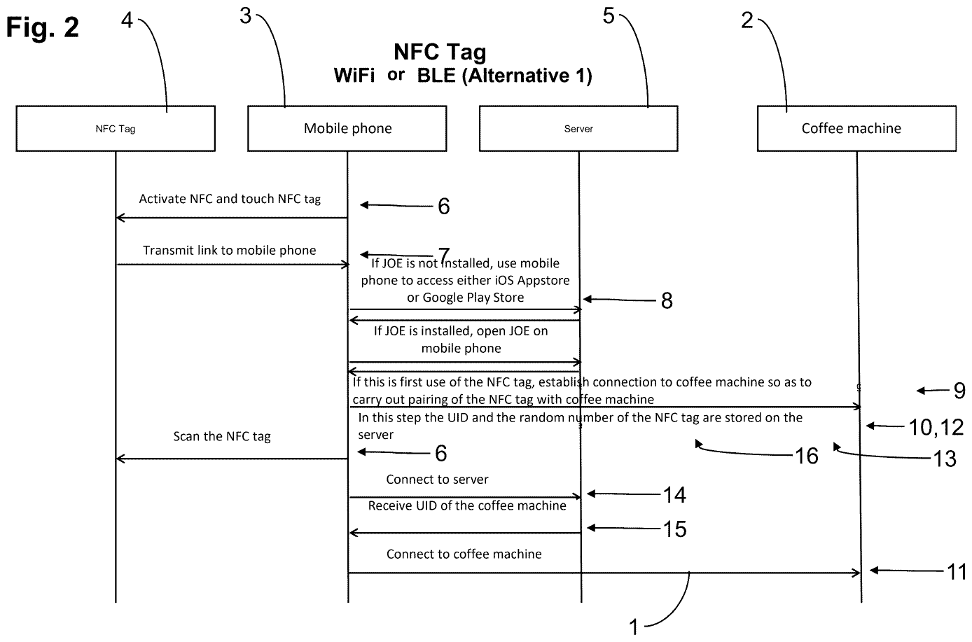

FIG. 2 shows a further exemplary embodiment in which, in contrast to the exemplary embodiments according to FIGS. 1 and 3, the assignment 11 between information 4 and machine-specific identifier 10 is not stored locally, but the assignment 11 is stored on an external memory 5, such as a server.

In this case, a check 9 as to whether a data connection 7 has already been established in the past for the information 4 read in can only be carried out if the household appliance 2 and/or the mobile terminal device 3 is connected to the external memory 5 or if the assignment 11 is also stored locally in the household appliance 2 and/or in the external terminal 3.

However, storing the assignment 11 on an external memory 5 offers the advantage that new mobile terminal devices 3 which have not yet read in the assigned information 4 and/or mobile terminal devices 3 which have not stored the assignment 11 locally still have access to the already stored assignment 11 of the identifier 10 to the information 4 when the information 4 is read in in a read step 6. As a result, a reception 15 of the assignment 11 is possible by establishing a connection 14 to the external memory 5, which is then used to establish the control connection 1.

### LIST OF REFERENCE SIGNS

1 Control connection
2 Household appliance
3 Mobile terminal device
4 Readable information
5 External memory
6 Reading in the information
7 Data connection
8 Checking whether the app for operating the control connection is installed and installation of the app if necessary
9 Checking a data connection already established in the past and/or whether a machine-specific identifier has already been assigned to the information in the past
10 Obtaining a machine-specific identifier
11 Assignment of the identifier to the information
12 Establishing a control connection
13 Saving the assignment of the identifier to the information
14 Establishing a connection to the server
15 Receiving the assignment of the identifier to the information
16 Information is modified

1. A method for establishing a control connection (1) between a household appliance (2) and a mobile terminal device (3) wherein externally readable information (4) that is independent of a machine-specific identifier (10) is arranged on or can be called up at the household appliance (2), the method comprising the following steps:
machine reading (6) of the information (4) using the mobile terminal device (3),
checking whether a data connection has already been established to the information (4) in the past and a machine-specific identifier (10) has been assigned (9), and,
if a result of the check is negative, establishing a data connection (7) between the household appliance (2) and the mobile terminal device (3) to obtain the machine-specific identifier (10) from the household appliance (2) and assignment (11) of the identifier (10) to the information (4), or,
if the result of the check is positive, using the identifier (10) to establish the control connection (12).

2. The method according to claim 1, further comprising when checking (9) whether the data connection (7) has already been established to the information (4) in the past, checking whether the machine-specific identifier (10) assigned to the information (4) and/or information about a successful check in the past is available in at least one of the mobile terminal device (3), on an external memory (5), or in the household appliance (2).

3. The method according to claim 1, further comprising when the data connection (7) is established, selecting the household appliance (2) on the mobile terminal device (3) from a list of available connection subscribers.

4. The method according to claim 1, wherein one of the assignment (11) of the identifier (10) to the information (4) is stored in at least one of the mobile terminal device (3) or in the household appliance (2).

5. The method according to claim 1, wherein the information (4) contains an individual character string with which the information (4) is adapted to be uniquely identified.

6. The method according to claim 1, further comprising, after reading in (6) the information (4), making an automatic check as to whether an associated app for operating the control connection is installed (8).

7. The method according to claim 1, wherein the information (4) is selectable independently of the identifier (10).

8. The method according to claim 1, wherein at least one of the establishment of the data connection (7) or the establishment (12) of the control connection (1) is adapted to be carried out locally.

9. The method according to claim 1, wherein the information (4) is adapted to be read at least one of mechanically, magnetically, electromagnetically, acoustically, or optically.

10. The method according to claim 1, further comprising storing the assignment (11) of the identifier (10) to the information (4) in a retrievable manner on an external memory (5).

11. A mobile terminal device (3) including a processor that is configured for carrying out the method according to claim 1.

12. A set consisting of the mobile terminal device (3) according to claim 11 and the household appliance (2), wherein information (4) for carrying out the method according to claim 1 is held ready on the household appliance.

13. A method for retrofitting a household appliance, the method comprising arranging externally readable information that is independent of a machine-specific identifier on or at the household appliance, and carrying out the method according to claim 1.

14. (canceled)

15. The method of claim 1, wherein the household appliance (2) is a coffee machine, and the mobile terminal device (3) is a smartphone.

16. The method of claim 6, wherein the automatic check further includes at least one of checking if a connection to the Internet is established to obtain an app if the associated app for operating the control connection is not installed, or calling up the app.

17. The method of claim 9, wherein the information (4) is provided at least one of on an RFID tag or in a two-dimensional matrix code.

18. The set of claim 12, wherein the information (4) is adapted to be read out at least one of mechanically, magnetically, electromagnetically, acoustically, or optically.

19. The set of claim 12, wherein the household appliance (2) is a coffee machine.
